(19) United States
(12) Patent Application Publication
(10) Pub. No.: US 2023/0085660 A1
(43) Pub. Date: Mar. 23, 2023

(54) Mobile Device Housing with Integrated Antenna Carrier

(71) Applicant: ZEBRA TECHNOLOGIES CORPORATION, Lincolnshire, IL (US)

(72) Inventor: Carl A. Thelemann, East Islip, NY (US)

(21) Appl. No.: 17/478,617

(22) Filed: Sep. 17, 2021

(51) Int. Cl. H01Q 1/22

(52) U.S. Cl. CPC H01Q 1/2266; H04M 1/026

(57) ABSTRACT

A housing for a mobile computing device, the housing comprising: a first frame including a perimeter wall encircling a housing interior, the perimeter wall having a carrier surface facing outwards from the housing interior; an antenna having a radiating element affixed to the carrier surface and separated from the housing interior by the perimeter wall; and a second frame having (i) an inner surface facing towards the housing interior, and (ii) an outer surface defining an exterior surface of the mobile computing device, the second frame affixed to the first frame and encasing at least a portion of the radiating element between the carrier surface and the inner surface of the second frame.

### BACKGROUND

The development of radio access technologies (e.g. 5G) and the incorporation of such technologies into mobile communication devices alongside earlier technologies (e.g. 4G), may involve the deployment of additional communications hardware in such devices. Devices such as smartphones and other handheld communication devices may have limited physical space to accommodate such communications hardware, and the deployment of additional hardware may therefore lead to suboptimal communications performance, including increased potential for electrical noise and/or interference.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a mobile computing device.

FIG. 2 is a diagram showing a simplified cross section of the device of FIG. 1.

FIG. 3 is a diagram showing an exploded view of the housing of the device of FIG. 1, from the rear.

FIG. 4 is a diagram showing an exploded view of the housing of the device of FIG. 1, from the front.

FIG. 5 is a flowchart of a method for assembling the device of FIG. 1.

FIG. 6 is a diagram of a carrier frame of the device of FIG. 1.

FIG. 7 is a diagram of the carrier frame of FIG. 6 following the deployment of antennas thereon.

FIG. 8 is a diagram of the carrier frame of FIG. 7, affixed to a shell.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a housing for a mobile computing device, the housing comprising: a first frame including a perimeter wall encircling a housing interior, the perimeter wall having a carrier surface facing outwards from the housing interior; an antenna having a radiating element affixed to the carrier surface and separated from the housing interior by the perimeter wall; and a second frame having (i) an inner surface facing towards the housing interior, and (ii) an outer surface defining an exterior surface of the mobile computing device, the second frame affixed to the first frame to encaseand encasing at least a portion of the radiating element between the carrier surface and the inner surface of the second frame.

Additional examples disclosed herein are directed to a method, comprising: providing a first frame including a perimeter wall to encircle a housing interior of a mobile computing device, the perimeter wall having a carrier surface facing outwards from the housing interior; affixing a radiating element of an antenna to the carrier surface, the radiating element separated from the housing interior by the perimeter wall; and affixing a second frame, having an inner surface facing towards the housing interior, on the first frame and encasing at least a portion of the radiating element between the carrier surface and the inner surface of the second frame, the second frame further including an outer surface defining an exterior surface of the mobile computing device.

Further examples disclosed herein are directed to a mobile computing device, comprising: mobile computing device, comprising: a display defining a front surface of the mobile computing device; a housing including: (i) a first frame including a perimeter wall encircling a housing interior, the perimeter wall having a carrier surface facing outwards from the housing interior; (ii) an antenna having a radiating element affixed to the carrier surface and separated from the housing interior by the perimeter wall; (iii) a second frame having (i) an inner surface facing towards the housing interior, and (ii) an outer surface defining a rear surface of the mobile computing device opposite the front surface, the second frame overmolded on the first frame to encase at least a portion of the radiating element between the carrier surface and the inner surface of the second frame; and (iv) a cover defining a bezel for the display, the cover affixed to the first frame.

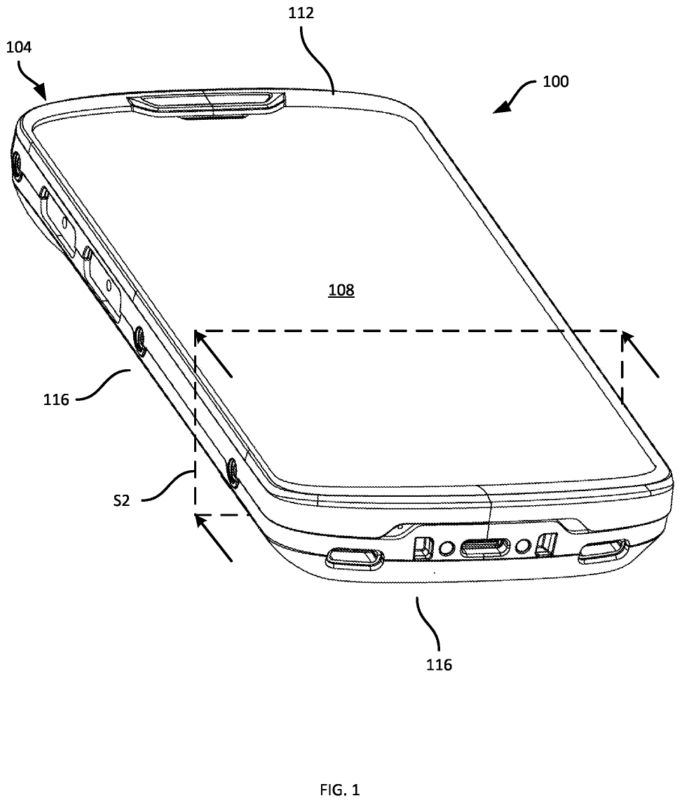

FIG. 1 shows a mobile computing device 100, such as a smart phone or other mobile computer. The device 100 includes a housing 104 supporting various other components of the device 100. Those other components include a display 108 supported by the housing and, in the illustrated example, surrounded by a bezel surface 112 formed by the housing 104. Certain components of the housing 104, as well as the display 108, form exterior surfaces of the device 100. In particular, the bezel 112 and display 108 form a front surface of the device 100, while other components of the housing 104, to be discussed below in greater detail, form sides 116 of the device and a back surface (not visible in FIG. 1) opposite the front surface.

The device 100 includes a housing interior, enclosed by the housing 104 and the display 108. The housing interior is a volume in which a variety of internal components of the device 100 are supported. The internal components can include controllers, storage devices, cameras, communications hardware, circuit boards and/or other support members, and the like. The above-mentioned communications hardware include one or more wireless communications interfaces. Each communications interface, in turn, can include a respective radio and/or baseband controller, as well as one or more antennas controllable to transmit and receive wireless signals. The communications interfaces can, for example, implement distinct wireless communications standards (e.g. WiFi, cellular standards such as 4G, 5G and the like).

As will be apparent to those skilled in the art, antenna performance (e.g. radiation patterns, gain, efficiency, etc.) can be affected not only by the geometry of the antenna, but also by the physical environment in which the antenna is deployed. Proximity to internal components such as the above mentioned controllers and the like, as well as to ground planes formed by circuit boards, can negatively affect antenna performance. Increasing the distance between the antennas and other internal components of the device 100 can mitigate such negative affects. However, space within the housing interior may be tightly constrained, such that few options may remain available for antenna deployment when locations for the remaining device components have been selected. The challenge of locating antennas within the housing interior while mitigating negative effects on antenna performance by neighboring components is exacerbated by the implementation of additional (e.g. newly developed) communications standards, requiring additional antennas and associated supporting hardware.

As will be discussed below, the housing 104 is therefore structured to enable the deployment of at least part of the antennas' radiating elements outside the housing interior. Specifically, the housing 104 includes at least two components, such as overmolded frames, that define at least part of the interior housing and the exterior surfaces of the device 100. The antennas, rather than being installed into the interior housing, are affixed between the above-mentioned frames. As a result, at least the radiating elements of the antennas are separated from the housing interior by a subset of the above-mentioned frames, while remaining protected from environmental exposure, impacts and the like, by another subset of the frames.

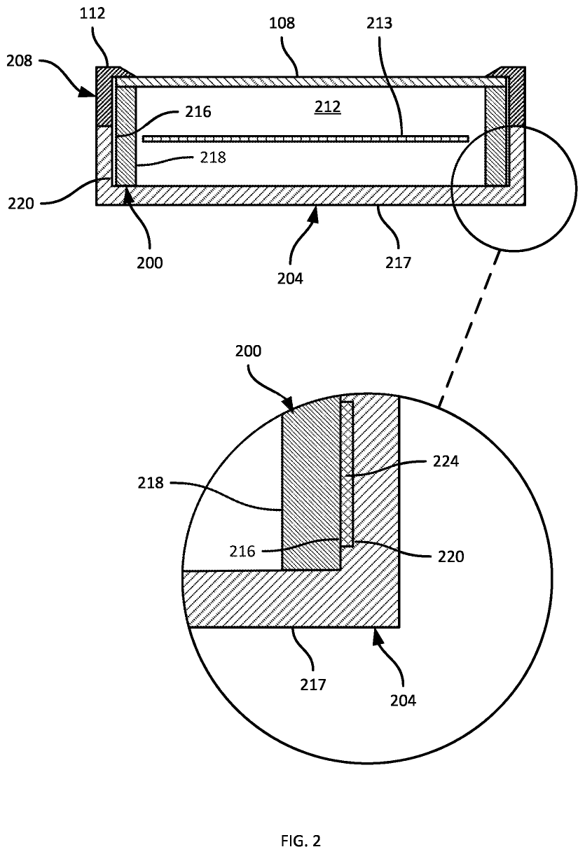

Referring to FIG. 2, a simplified cross-sectional view of the housing 104 is illustrated, taken at the plane S2 shown in FIG. 1. As shown in FIG. 2, the housing 104 includes three components. In particular, the housing 104 includes a carrier frame 200, which can also be referred to as an inner frame. The housing 104 further includes a shell 204, which can also be referred to as an outer frame, and a cover 208 that provides the bezel surface 112 introduced in FIG. 1.

The carrier frame 200 and shell 204 together define a housing interior 212, into which other internal components, such as a printed circuit board (PCB) 213, can be installed. That is, the housing interior 212 is a volume bounded by the inside (i.e. closer to the center of mass of the device 100) surfaces of the carrier frame 200 and the shell 204, as well as the inside surface of the display 108. As also seen in FIG. 2, the display 108 is mounted to the carrier frame 200, and retained against the carrier frame 200 by the cover 208, which engages with the shell 204 to enclose the carrier frame 200.

The carrier frame includes a carrier surface 216 on the outside thereof. That is, the carrier surface 216 faces away from the housing interior 212, opposite an inner surface 218 of the carrier frame 200. The carrier surface 216, although outside the housing interior, is not exposed to the exterior of the device 100 when the device 100 is fully assembled, as a result of the carrier frame 200 being enclosed within the shell 204 and the cover 208. Instead, the exterior surfaces of the device 100 are defined by the display 108, the cover 208, and an outer surface 217 of the shell 204. As will be discussed below in greater detail, the carrier surface 216 is referred to as such because the carrier surface 216 bears at least the radiating elements of one or more antennas of the device 100. The antennas are therefore separated from the housing interior 212 by the carrier frame 200, while remaining protected from environmental exposure by the shell 204 and the cover 208. Specifically, the radiating elements of the antennas are disposed on the carrier surface, and are covered by an inner surface 220 of the shell 204. The detail view of FIG. 2 illustrates an example antenna 224 encased between the carrier surface 216 (to which the antenna 224 is affixed) and the inner surface 220 of the shell 204. Although the inner surface 220 of the shell 204 and the carrier surface 216 are shown with a space therebetween in the upper portion of FIG. 2 to visually distinguish the two surfaces, the surfaces 216 and 220 may be in direct contact in at least some areas, e.g. because the shell 204 is overmolded onto the carrier frame 200.

The antennas can therefore be installed with greater separation between the radiating elements of the antennas and other electrical components of the device 100 (which are mounted inside the housing interior 212). The increased separation between radiating elements and other electrical components may in turn mitigate negative effects of such electrical components on antenna performance.

Although the housing 104 is illustrated as having the above-mentioned three components (the carrier frame 200, the shell 204, and the cover 208), in other examples one or more of the carrier frame 200, the shell 204, and the cover 208 can be implemented as a plurality of distinct components. For example, the shell 204 can be implemented as more than one separate component, which together cooperate with the cover 208 to enclose the carrier frame 200.

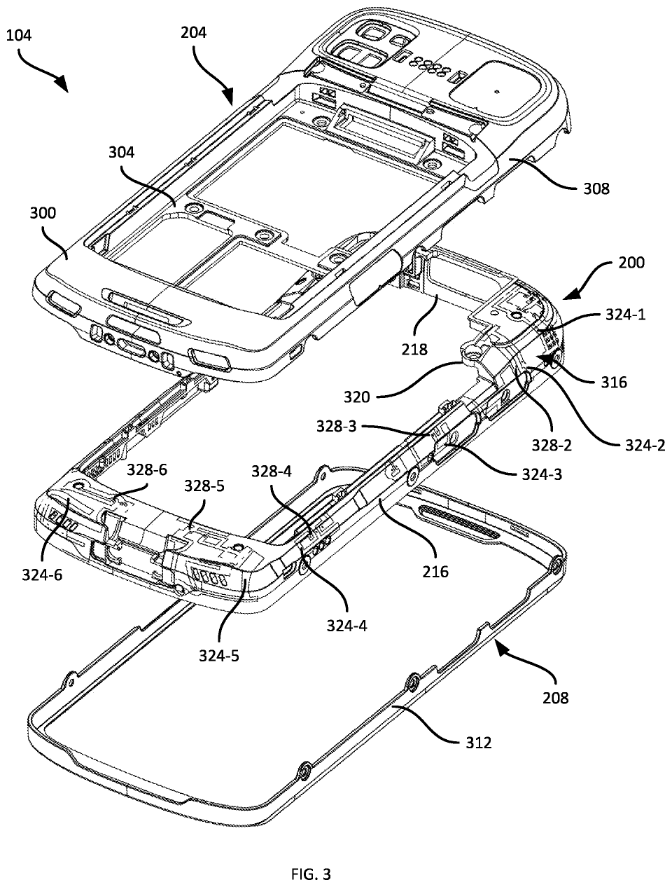

Turning to FIG. 3, an exploded view of the housing 104 is shown from the back of the device 100 (i.e. with the bezel surface 112 facing away and therefore not visible). As seen in FIG. 3, the shell 204 defines certain external surfaces of the device 100. In particular, the shell 204 defines a back surface 300, e.g. with an opening 304 therein to receive a battery pack, not shown. The shell 204 also includes side walls 308 extending around a perimeter of the shell 204, and defining rear portions of each side 116 of the device 100. The cover 208, meanwhile, includes side walls 312 defining forward portions (i.e. closer to the display 108) of the sides 116. The side walls 308 and 312, when the housing 104 is fully assembled, engage with each other to form the sides 116, and enclose the carrier frame 200.

The carrier frame 200 includes a perimeter wall 316 encircling the housing interior 212 and defining the carrier surface 216 as mentioned above in connection with FIG. 2. The carrier surface 216, in other words, extends around the outside of the carrier frame 200. The perimeter wall 316 also defines the above-mentioned inner surface 218. In some examples, the carrier frame 200 can include additional components affixed to the perimeter wall 316, such as one or more anchors 320 extending into the housing interior 212. The anchors can receive fasteners or other coupling mechanisms in order to affix internal components (e.g. circuit boards and the like) of the device 100 to the carrier frame 200. The shell 204 can also include one or more anchors, in some examples.

As seen in FIG. 3, the carrier frame 200 includes a plurality of antennas 324 affixed to the carrier surface 216. In particular, antennas 324-1, 324-2, 324-3, 324-4, 324-5, and 324-6 are visible in FIG. 3, although further antennas 324 may also be disposed on the carrier surface 216. More generally, any of a wide variety of antennas 324 can be affixed to the carrier surface 216, each disposed in a corresponding region of the carrier surface 216. The regions assigned to each antenna 324 are spaced apart, to mitigate interactions between the antennas 324 themselves. The antennas 324 can implement a plurality of communications standards. For example, distinct subsets of the antennas (e.g. the antenna 324-1 and 324-3 in one subset, and the antennas 324-2, 324-4, and 324-5 in another subset) can implement distinct communications standards, such as WiFi, 4G, 5G, and the like.

The antennas 324 are implemented in this example as conductive traces, e.g. metallic strips affixed to the carrier surface 216. Each antenna 324 includes a radiating element (visible in FIG. 3) as well as one or more feed lines (e.g. an Rx feed line and a Tx feed line) connecting the radiating element to internal components of the device 100 such as transceivers and the like. The feed lines extend from the carrier surface 216 to the housing interior 212, e.g. through openings 328 through the perimeter wall 316. Example openings 328-2, 328-3, 328-4, 328-5, and 328-6 are illustrated in FIG. 3, extending from the carrier surface 216 through the perimeter wall 316 to the inner surface 218. The entirety of each antenna 324 therefore need not be affixed to the carrier surface 216 such that it is separated from the housing interior 212 by the perimeter wall 316. The radiating elements of the antennas 324, however, are entirely, or substantially entirely, affixed to the carrier surface 216 to separate the radiating elements from internal electronics of the device 100.

As will now be apparent from FIGS. 2 and 3, the placement of the antennas 324 on the carrier surface 216 results in the antennas 324 (or at least the radiating elements thereof) being encased between the carrier surface 216 and the inner surface 220 of the shell 204 when the shell 204 and the carrier frame 200 are assembled.

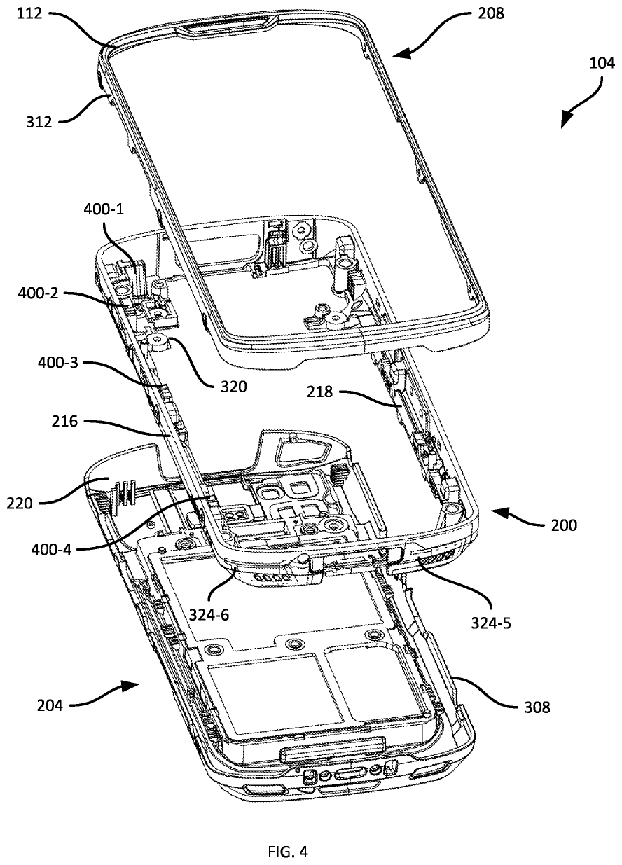

Turning to FIG. 4, an exploded view of the housing 104 is shown from the front. In addition to the elements noted above in connection with FIG. 3, certain feed lines of the antennas 324 are visible. In particular, pairs of feed lines 400-1, 400-2, 400-3, and 400-4 corresponding respectively to the antennas 324-1, 324-2, 324-3, and 324-4 are shown extending into the housing interior 212 on the carrier frame 200. The feed lines 400 extend from the carrier surface 216, through the above-mentioned openings 328, to the housing interior 212, where they can be connected to internal controllers or other communications hardware.

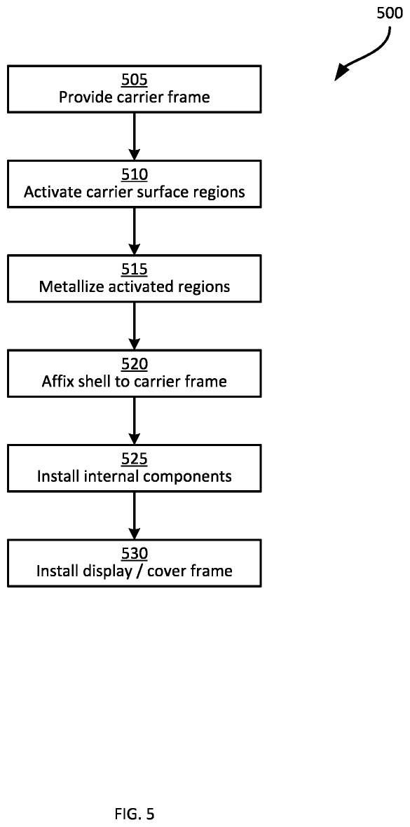

Referring to FIG. 5, a method 500 for fabricating the housing 104 and assembling the device 100 is illustrated. In particular, the method 500 illustrates a mechanism by which the carrier frame 200 and shell 204 can be provided and affixed to one another in order to deploy the antennas 324 outside the housing interior 212.

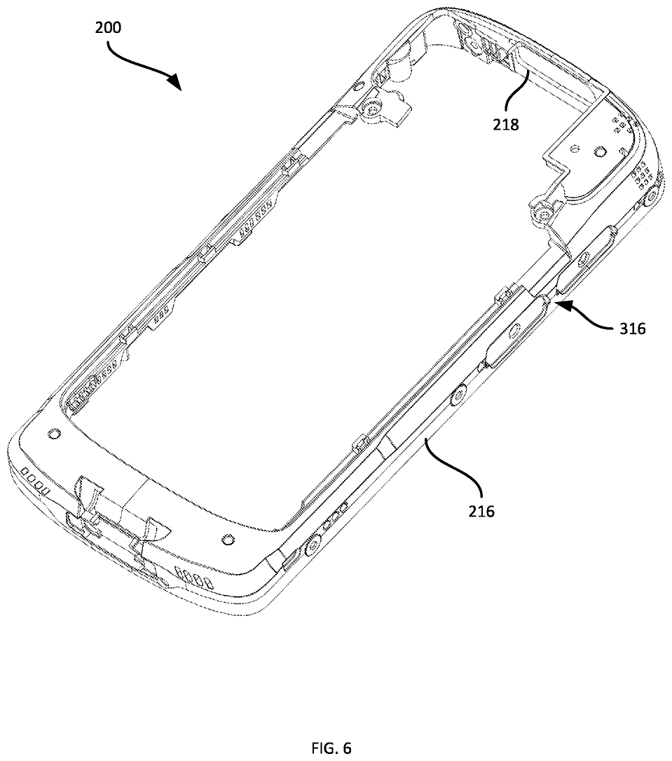

At block 505, the carrier frame 200 is provided, e.g. by injection molding or any other suitable process. In the examples illustrated above, the carrier frame 200 is molded in a single shot of a suitable plastic or other material. In other examples, the carrier frame 200 can be fabricated in multiple pieces that are then joined to provide the complete carrier frame 200. The material(s) employed to fabricate the carrier frame 200 includes an activatable material, e.g. as an additive in a base thermoplastic. The additive can include a metallic inorganic compound that can be activated by laser light. FIG. 6 illustrates the carrier frame 200 following the performance of block 505. As seen in FIG. 6, the carrier frame 200 does not yet include the antennas 324.

At block 510, regions on the carrier surface 216 that are to receive the antennas 324 are activated, e.g. by exposing those regions to laser light. One or more laser emitters, for example, can be controlled to illuminate the above-mentioned regions, e.g. by illuminating the carrier surface 216 along predefined paths on the carrier surface 216 corresponding to the locations and shapes of the antennas 324. Such exposure activates the above-mentioned additive, configuring the activated regions to receive and bind conductive material forming the antennas 324.

At block 515, the regions activated at block 510 are metallized, to deposit or otherwise affix conductive material (e.g. copper or other suitable conductors) forming the antennas 324 to the carrier surface 216. For example, at block 515 the carrier frame 200 can be immersed in one or more baths containing the conductive material(s) in solution. The conductive material(s) are thus deposited on the activated regions of the carrier surface 216, but not on the remainder of the carrier frame 200. As will now be apparent to those skilled in the art, the fabrication of the carrier frame 200 and antennas 324 is implemented via laser direct structuring (LDS) in this example.

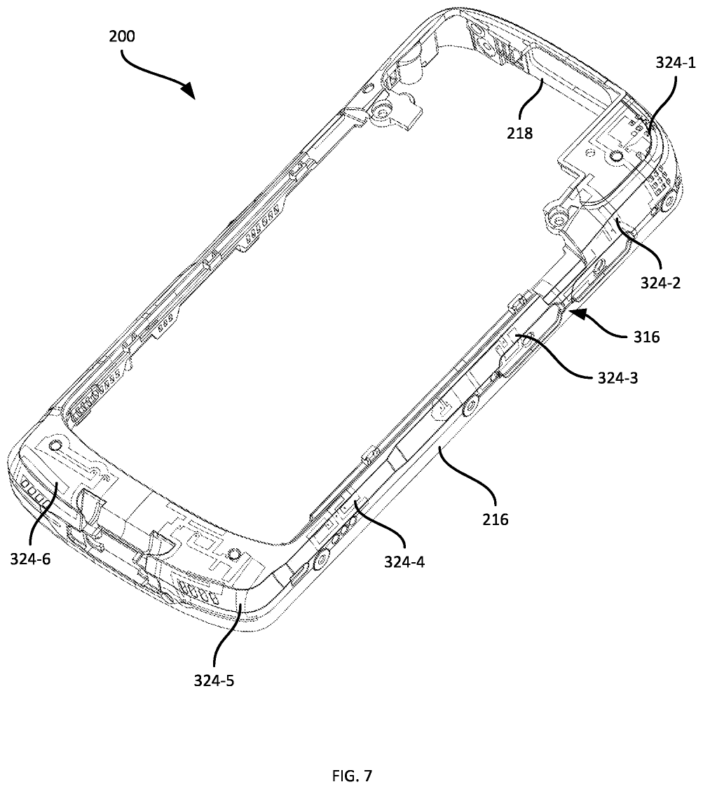

As noted earlier, the carrier frame 200 also includes openings 328 for the feed lines 400 of the antennas 324 to connect the radiating elements on the carrier surface 216 to the housing interior 212. The openings 328 can be provided along with the molding of the carrier frame 200, or in other examples can be drilled or otherwise applied to the carrier frame 200 after molding, but before metallizing at block 515. FIG. 7 illustrates the carrier frame 200 following the performance of blocks 510 and 515, with the antennas 324 affixed to the carrier surface 216.

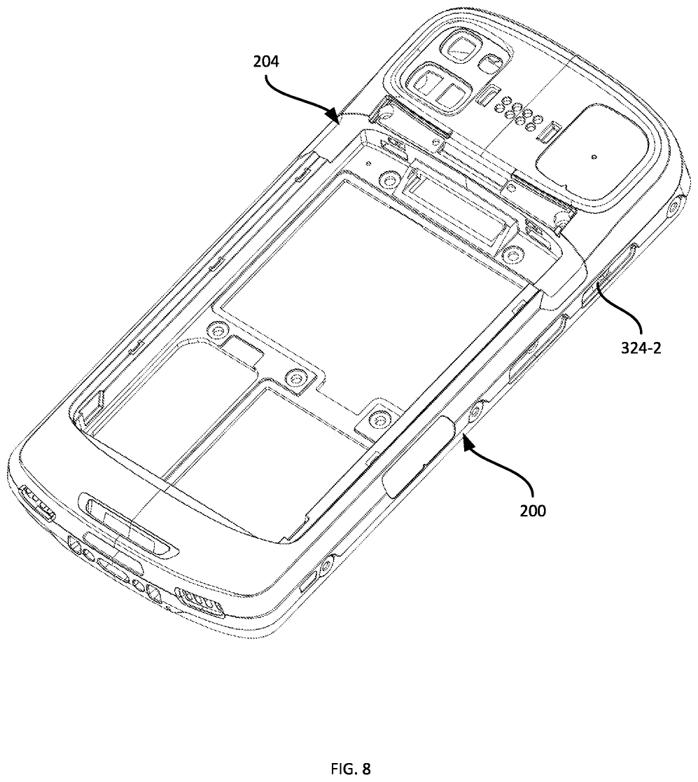

Returning to FIG. 5, at block 520, the shell 204 is affixed to the carrier frame 200. In the present example, the shell 204 is overmolded onto the carrier frame 200, e.g. by placing the carrier frame 200 (with the antennas 324) in a mold and applying the material forming the shell 204 thereto. In other examples, the shell 204 can be affixed to the carrier frame 200 by another suitable mechanism, e.g. adhesives or the like. FIG. 8 illustrates the carrier frame 200 and the shell 204 after the performance of block 520. The shell 204 encases at least a rear portion of the radiating elements of the antennas 324 between the inner surface 220 of the shell 204, and the carrier surface 216. Some antennas, such as the antenna 324-2, have forward portions that are not entirely enclosed, depending on the configuration of the antenna 324 on the carrier surface 216. Those exposed portions are enclosed later in the assembly process, by the cover 208.

At block 525, the internal components of the device 100 are installed, at block 530, the display 108 and cover 208 are installed. The order and manner in which the internal components are installed into the housing interior 212 is not particularly limited. In general, the internal components can be affixed to either or both of the carrier frame 200 (e.g. via anchors such as the anchor 320 shown in FIG. 3) and the shell 204, and/or to other internal components. When the installation of the internal components is complete, the display 108 can be installed over the housing interior, and affixed to the housing 104 by the cover 208. The side walls 312 of the cover 208 enclose the forward portion of the perimeter wall 316 and engage with the shell 204 to completely enclose the carrier frame 216 and antennas 324.

As a result of the above assembly process, and in particular the provision of the antennas 324 on the carrier surface 216, the antennas 324 can be deployed in positions that mitigate interference from components within the housing interior 212, while protecting the antennas 324 from impacts and other environmental factors.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A housing for a mobile computing device, the housing comprising:
a first frame including a perimeter wall encircling a housing interior, the perimeter wall having a carrier surface facing outwards from the housing interior;
an antenna having a radiating element affixed to the carrier surface and separated from the housing interior by the perimeter wall; and
a second frame having (i) an inner surface facing towards the housing interior, and (ii) an outer surface defining an exterior surface of the mobile computing device, the second frame affixed to the first frame and encasing at least a portion of the radiating element between the carrier surface and the inner surface of the second frame.

2. The housing of claim 1, wherein the second frame is affixed to the first frame by overmolding.

3. The housing of claim 1, wherein the second frame is affixed to a rear portion of the perimeter wall.

4. The housing of claim 3, further comprising a cover affixed to a forward portion of the perimeter wall to enclose the first frame within the second frame and the cover frame.

5. The housing of claim 1, wherein the first frame includes an anchor configured to support an internal component of the mobile computing device within the housing interior.

6. The housing of claim 1, wherein the antenna is affixed to the carrier surface by metallization of an activated region of the carrier surface.

7. The housing of claim 1, wherein the antenna includes a feed line extending from the radiating element into the housing interior.

8. The housing of claim 7, wherein the first frame includes an aperture from the carrier surface to the housing interior; and wherein the feed line extends through the aperture to connect the radiating element to a controller mounted in the housing interior.

9. The housing of claim 1, wherein the housing comprises a plurality of antennas, having respective radiating elements affixed to respective spaced-apart regions of the carrier surface.

10. The housing of claim 9, wherein a first subset of the plurality of antennas implement a first communication standard; and wherein a second subset of the plurality of antennas implement a second communication standard.

11. A method, comprising:
providing a first frame including a perimeter wall to encircle a housing interior of a mobile computing device, the perimeter wall having a carrier surface facing outwards from the housing interior;
affixing a radiating element of an antenna to the carrier surface, the radiating element separated from the housing interior by the perimeter wall; and
affixing a second frame, having an inner surface facing towards the housing interior, on the first frame and encasing at least a portion of the radiating element between the carrier surface and the inner surface of the second frame, the second frame further including an outer surface defining an exterior surface of the mobile computing device.

12. The method of claim 11, wherein affixing the second frame includes overmolding the second frame onto the first frame.

13. The method of claim 11, wherein providing the first frame includes molding the first frame.

14. The method of claim 11, wherein affixing the radiating element includes, prior to affixing the second frame:
(i) activating a region of the carrier surface, and
(ii) depositing the radiating element onto the activated region.

15. The method of claim 11, further comprising:
installing an internal component of the mobile computing device into the housing interior; and
securing the internal component to an anchor of the first frame.

16. The method of claim 11, further comprising:
applying a cover to a forward portion of the first frame, to enclose the first frame between the cover and the second frame.

17. A mobile computing device, comprising:
a display defining a front surface of the mobile computing device;
a housing including:
(i) a first frame including a perimeter wall encircling a housing interior, the perimeter wall having a carrier surface facing outwards from the housing interior;
(ii) an antenna having a radiating element affixed to the carrier surface and separated from the housing interior by the perimeter wall;
(iii) a second frame having (i) an inner surface facing towards the housing interior, and (ii) an outer surface defining a rear surface of the mobile computing device opposite the front surface, the second frame overmolded on the first frame to encase at least a portion of the radiating element between the carrier surface and the inner surface of the second frame; and
(iv) a cover defining a bezel for the display, the cover affixed to the first frame.

18. The mobile computing device of claim 17, wherein the cover is configured to engage with the second frame to enclose the first frame.

19. The mobile computing device of claim 17, wherein the housing includes a plurality of antennas, having respective radiating elements affixed to respective spaced-apart regions of the carrier surface.

20. The mobile computing device of claim 17, wherein the antenna includes a feed line extending from the radiating element into the housing interior.
